(19) United States
(12) Patent Application Publication
(10) Pub. No.: US 2004/0143085 A1
(43) Pub. Date: Jul. 22, 2004

(54) Method for processing urethane resin, decomposed substance of urethane resin, recycled resin and method for producing the same

(75) Inventors: Taro Fukaya, Kanagawa-ken (JP); Cao Minh Thai, Kanagawa-ken (JP); Shioko Saya, Kanagawa-ken (JP); Shinetsu Fujieda, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/718,527

(22) Filed: Nov. 24, 2003

(30) Foreign Application Priority Data
Nov. 22, 2002 (JP) 2002-338882

(51) Int. Cl. C08G 18/16; C08G 18/08

(52) U.S. Cl. 528/48

(57) ABSTRACT

A novel method for decomposing urethane resin suppresses the generation of aromatic amines and facilitates the recycling of urethane resins. To decompose urethane resin, the method involves the use of a decomposing agent that has both an ability to cleave urethane bonds in a urethane resin and an ability to react with and thus capture an amine compound. The decomposing agent is preferably one that contains either at least one selected from carboxyl group, and a salt, ester and acid anhydride thereof, or at least one selected from isocyanate group and epoxy group.

### CROSS REFERENCE TO RELATED APPLICATION

This application is based upon and claims the benefit of priority from the prior Japanese Patent Application No. 2002-338882, filed on Nov. 22, 2002; the entire contents of which are incorporated herein by reference.

### BACKGROUND OF THE INVENTION

1. Field of the Invention

The present invention generally relates to processing of urethane resins. Specifically, the present invention relates to a method for processing a urethane resin that allows the production of readily recyclable decomposed substance of urethane resin, as well as to such decomposed substance. The invention further relates to a recycled resin made from the decomposed substance of urethane resin, as well as to a method for producing such recycled resin.

2. Description of the Related Art

Urethane resins are widely used in heat-insulators of refrigerators, as well as in building materials, cushioning materials and various other applications. In response to the increasing demand to recycle waste urethane materials, studies have been conducted in relevant fields to find practical solutions. Being thermosetting resins having three-dimensional network structure, urethane resins are difficult to recycle and are currently disposed as a landfill material or by incineration.

Many techniques have been known for chemical recycling of urethane resins. Among such techniques are degradation of polyurethane foam by the use of an amine compound such as alkanolamine, followed by separation/collection of the decomposed substance; degradation of polyurethane foam by using polyol and aminoethanol as decomposing agents, which allows the decomposed substance to be recycled as an auxiliary adhesive; ketone/aldehyde degradation; thermal degradation; and hydrolysis. However, any of these degradation techniques generates 4,4′-methylenedianiline (MDA), or 2,4-tolylenediamine or 2,6-tolylenediamine (TDAs), each an isocyanate-derived aromatic amine. These compounds act as a catalyst during formation of a recycled resin from the decomposed substance of a urethane resin and thus make the recycle process difficult.

When it is desired to recycle the decomposed substances obtained by the above-described process as a material to form a new resin, the MDA and TDA generated during the process must be inactivated by chemical process. One approach to consume and inactivate these amines that are present in the decomposed substance of urethane resin is to decompose the urethane resin by using an alcoholate, which can be made from an alcohol and an alkali metal, and add an alkylene oxide, such as propylene oxide, to the decomposed substance of the urethane resin. The decomposed substance obtained in this process, however, compound containing urea-group or 2-oxazolidone. When exposed to an alkali metal hydroxide in the reaction system, these compounds are decomposed to form carbonates, which require an extra step to separate them and thus make this approach unattractive. Another approach is to decompose rigid polyurethane foam in a monoalkanolamine having 2 or 3 carbon atoms to form a solution of a decomposed substance and add an alkylene oxide in the presence of an amine catalyst. Still another approach is also known that involves addition of an isocyanate or an epoxy resin to a chemically decomposed substance of polyurethane. In each of these approaches, a decomposing agent and a treatment agent are used successively, so that the degradation process and the treatment process must be performed individually. In addition, the treatment process in these approaches is inherently complicated. These conditions add to the complexity of the entire process.

In a still further technique known as isocyanate degradation, polyurethane is decomposed by the addition of an isocyanate compound (See, Japanese Patent Laid-Open Publication No. Hei 5-222152). Specifically, the isocyanate compound used to decompose and liquefy the polyurethane contains 5 equivalents or more of NCO groups with respect to the hydroxyl groups used in the production of the polyurethane. This process generates a compound containing a terminal isocyanate group, which is a potentially hazardous material to human health and is thus difficult to handle. This recycle process of polyurethane requires a relatively large amount of the isocyanate compound relative to the amount of the polyurethane used. For this reason, the recycle rate of the process is low, which makes the process inappropriate for processing large quantities of polyurethane.

As described, any of the conventional approaches for decomposing urethane resins generates in aromatic amines generated in the resulting decomposed substances. Such decomposed substances are inappropriate for recycling. Also, each of the conventional treatment processes for reducing aromatic amines is relatively complicated. These conditions add to the complexity of the entire process. Furthermore, none of these approaches can achieve high recycle rate.

### SUMMARY OF THE INVENTION

Accordingly, it is an objective of the present invention to provide a novel technology for urethane resin processing that, while achieving high recycle rate of urethane resin, can reduce the generation of aromatic amines and other amine compounds in a simple and effective manner.

A first aspect of the present invention relates to a method for processing urethane resins. This method comprises the step of adding to a urethane resin a decomposing agent that contains at least one functional group selected from the group consisting of a carboxyl group (—COOH), and a salt, an ester and an acid anhydride (—CO—O—CO—) thereof to thereby decompose the urethane resin.

A second aspect of the present invention relates to another method for processing urethane resins. This method comprises the step of adding to a urethane resin a decomposing agent that contains at least one functional group selected from the group consisting of an isocyanate group (—NCO) and an epoxy group. The decomposing agent is added in an amount that provides 0.1 to 2 equivalents of the functional group for each equivalent of urethane/urea bond in the urethane resin to thereby decompose the urethane resin.

A third aspect of the present invention relates to a decomposed substance of a urethane resin. The decomposed substance is characterized in that it is produced by decomposing a urethane resin by adding to the urethane resin either a decomposing agent that contains at least one functional group selected from the group consisting of a carboxyl group (—COOH), a salt, an ester and an acid anhydride group (—CO—O—CO—) thereof, or a decomposing agent that contains at least one functional group selected from the group consisting of an isocyanate group (—NCO) and an epoxy group.

A fourth aspect of the present invention relates to a method for producing a recycled resin. This method comprises the steps of adding to a urethane resin either a decomposing agent that contains at least one functional group selected from the group consisting of a carboxyl group (—COOH), and a salt, an ester and an acid anhydride (—CO—O—CO—) thereof, or a decomposing agent that contains at least one functional group selected from the group consisting of an isocyanate group (—NCO) and an epoxy group to thereby decompose the urethane resin; and reacting the resultant decomposed substance of the urethane resin with a compound that contains at least one functional group selected from the group consisting of an epoxy group and an isocyanate group.

A fifth aspect of the present invention relates to a recycled resin. This recycled resin is characterized in that it is produced by adding to a urethane resin either a decomposing agent that contains at least one functional group selected from the group consisting of a carboxyl group (—COOH) and a salt, an ester and an acid anhydride (—CO—O—CO—) thereof, or a decomposing agent that contains at least one functional group selected from the group consisting of an isocyanate group (—NCO) and an epoxy group to thereby decompose the urethane resin; and then reacting the resultant decomposed substance of the urethane resin with a compound that contains at least one functional group selected from the group consisting of an epoxy group and an isocyanate group.

### BRIEF DESCRIPTION OF THE DRAWINGS

FIG. 1 is a schematic view showing one embodiment of a processing apparatus for implementing a method for urethane resin processing in accordance with the present invention;

FIG. 2 is a diagram showing the effect of the weight ratio of urethane to a decomposing agent on the TDA generation in the method for urethane resin processing in accordance with the present invention;

FIG. 3 is a diagram showing the effect of the time length over which urethane is maintained in the apparatus on the TDA generation in the method for urethane resin processing in accordance with the present invention; and

FIG. 4 is a diagram showing the effect of the temperature at which urethane is decomposed on the TDA generation in the method for urethane resin processing in accordance with the present invention.

### DETAILED DESCRIPTION OF THE INVENTION

In the course of our studies, the present inventors have discovered that a decomposing agent that has not only an ability to cleave the urethane bonds but also an ability to capture amine groups can be a practical solution to the above-described problems of the conventional urethane processing techniques. The finding eventually led the present inventors to devise the present invention. Unlike the conventional approaches, in which a decomposing agent and a treatment agent are used individually, the present invention makes use of a compound that has the abilities of the two agents in combination, so that the two processes, degradation and treatment, are combined in one simple process. The decomposed substances produced in this manner contain decreased amounts of amine compounds, including aromatic amines.

A description will now be given of the principles and effects of the present invention.

Urethane resins are decomposed by cleaving urethane bonds in the resins. Upon cleavage of the urethane bonds in the urethane resins, amino compounds are generated though their amounts may vary depending on the type of the cleavage technique employed. Among such amino compounds are methylenedianiline (MDA) and tolylenediamine (TDA), which are respectively generated when isocyanate groups (—NCO) of 4,4′-diphenylmethanediisocyanate (MDI) and tolylenediisocyanate (TDI), each a common material for urethane, are converted into amino groups (—NH₂). During the recycle process of the urethane resin to form a recycled resin, the amino compounds act as catalysts and accelerate the polymerization or condensation reaction of the decomposed product to a degree that is difficult to control. For this reason, the amino compounds must be inactivated in a reaction with some other compounds to decrease the reaction rate. Taking advantage of a decomposing agent that has an ability to cleave urethane bonds in combination with an ability to react with and capture amino groups, the present invention allows the capturing of the generated aromatic amines to take place simultaneously with the degradation of urethane, thereby eliminating the above-described problems of prior art. Also, the decomposed substances obtained by the method of the present invention have proven to contain less aromatic amines than the decomposed substances obtained by the conventional techniques. In addition, if the compound to serve as the decomposing agent includes a hydroxyl group, it not only acts to capture the aromatic amine but also acts to convert the amino groups into hydroxyl groups. The conversion of the terminal amino groups of the decomposed substance of resin into hydroxyl groups facilitates the bond formation during formation of a recycled resin and is thus advantageous.

According to the above-described process of the present invention, less aromatic amines remain in the decomposed substance of the resin and, depending on the type of the decomposing agent, the terminal amino groups are converted into hydroxyl groups. As a result, the decomposed substances of the present invention are better suited for recycling purposes than the decomposed substances obtained by other decomposing techniques.

The decomposing agent for use in the present invention may be any decomposing agent that has an ability to cleave the urethane bonds in urethane resins in combination with an ability to react with and capture amino compounds. Specific examples of such decomposing agents include compounds with an epoxy group, compounds with a carboxyl group, salts, esters, and acid anhydrides thereof, and compounds with an isocyanate group (—NCO).

### BEST MODE FOR CARRYING OUT THE INVENTION

The present invention will now be described in detail with reference to several embodiments.

[First Embodiment]

In this embodiment, carboxylic compounds and derivatives thereof, including salts, esters and acid anhydrides thereof, are used to serve as a decomposing agent. The decomposing agent is added to a urethane resin, which serves as a resin to be processed. The urethane resin, along with the decomposing agent, is heated to bring about the degradation of the resin. The process is described in detail in the following.

Urethane Resin for Processing

The urethane resin to be processed in the present embodiment may be any type of urethane resin that contains urethane bonds or urea bonds. For example, the urethane resin may be a rigid urethane, flexible urethane, semi-rigid urethane or urethane elastomer. It may also be an isocyanurate resin containing isocyanurate bonds. Of these materials, flexible urethane resin is particularly preferred. As used herein, the term “flexible urethane” is defined as urethane synthesized using polyol having a hydroxyl value of 250 mg KOH/g or less. Containing relatively small amounts of urethane/urea bonds, flexible urethane resins are highly susceptible to degradation and can thus produce significant results when used in the present invention.

Decomposing Agents: Decomposing Agents Containing Carboxyl Groups or Derivatives Thereof

Decomposing agents for use in the present embodiment are those containing functional groups such as carboxyl groups, and salts, esters and acid anhydride groups thereof. Examples of the compounds containing carboxyl groups or acid anhydride groups include organic acids, such as formic acid, acetic acid, propionic acid, butyric acid, isobutyric acid, itaconic acid, propiolic acid, oleic acid, acrylic acid, methacrylic acid, oxalic acid, maleic acid, fumaric acid, phthalic acid, malonic acid, succinic acid, adipic acid, benzoic acid, citraconic acid, crotonic acid, glutaric acid, hexanoic acid, glycolic acid, lactic acid, malic acid, tartaric acid, citric acid, saccharic acid, glyceric acid, gluconic acid, salicylic acid, trimellitic acid, cycropentane tetracarbonmethyl hexahydrophthalic acid, and hexahydrophthalic acid, and compounds formed by intramolecular dehydration of the preceding organic acids, such as acid anhydrides and lactones. Compounds that contain a carboxyl group and an acid anhydride within their molecules, such as trimellitic anhydride, may also be used. Other examples of the decomposing agents for use in the present embodiment include salts of the foregoing organic acids, including those formed with sodium, potassium, and calcium, and esters that the foregoing organic acids form with hydroxyl group, including methyl acetate, ethyl acetate, and propyl acetate. Still other examples of the decomposing agents include amino acids, such as glycine, alanine, valine, leucine, isoleucine, glutamine, serine, phenylalanine, and glutamic acid, compounds in which two or more molecules of these amino acids are bound to one another, and imino acids containing intramolecular bonds, such as proline. Optical isomers of these compounds may also be used in exactly the same manner.

These decomposing agents may be used either individually or as a mixture of two or more decomposing agents. The decomposing agents may be mixed with a known decomposing agent, such as a polyol, amine, and alkanolamine, or other diluents. They may also be mixed with an epoxy compound or an isocyanate compound, which will be described later.

To carry out the actual degradation process, the decomposing agent may be selected depending on the type of urethane to be decomposed, conditions of the degradation process, and intended applications of the decomposed substance, and by taking into consideration the following points.

During the reaction of the decomposing agent of the present invention with a TDA generated upon degradation of urethane, the amino group at the ortho-position relative to the methyl group is less susceptible to reaction with the decomposing agent because of steric hindrance. For this reason, when intended for use with flexible urethanes of the type that generates a significant amount of TDA upon degradation, the decomposing agent preferably does not contain a benzene ring and has 10 or less carbon atoms or, if it contains a benzene ring, it preferably has a molecular weight of 120 or less when measured without functional groups. Among such degradation agents are lactic acid, succinic anhydride, and phthalic anhydride.

Most reactive of all the decomposing agents of the present invention are those with an acid anhydride group. Thus, when it is desired to reduce the reaction time to thereby allow industrial-scale processing, or when it is desired to minimize the amount of the decomposing agent (specifically, 5 parts by weight or more of urethane with respect to 1 part by weight of the decomposing agent), or when the urethane is one with a high crosslinking density, such as rigid urethane, the decomposing agents with an acid anhydride group are preferred. Among such decomposing agents are phthalic anhydride, benzoic anhydride, acetic anhydride, and succinic anhydride.

A porous material, urethane resin can absorb the liquid decomposing agent upon mixing. This often results in decreased dispersibility of the decomposing agent. To ensure the dispersibility, the decomposing agent is preferably one that takes a solid form at room temperature (with a melting point of 40° C. or higher) and is preferably crushed to 1 mm or less in size prior to use. Examples of such decomposing agents include phthalic anhydride, succinic anhydride, salicylic acid, and glycine.

When a decomposing agent with a relatively low boiling point is placed in a high-temperature decomposing apparatus along with urethane resin, it may evaporate before the desired degradation of urethane takes place. Thus, the decomposing agent preferably has a boiling point of 150° C. or higher when the degradation process is to be carried out at a temperature of 200° C. or above and preferably has a boiling point of 200° C. or higher when the degradation process is to be carried out at a temperature of 250° C. or above. Examples of such decomposing agents include phthalic anhydride, succinic anhydride, and salicylic acid.

Should the decomposing agent contain two or more functional groups, it may react with other compounds existing in the decomposed substance of urethane and polymerize. For this reason, it is preferred that the decomposing agent contain only one functional group when the decomposing agent is used in a large amount (i.e., seven parts by weight or less of urethane with respect to one part by weight of the decomposing agent), when the reaction mixture is heated for a time period of 1 hour or longer, or when the reaction temperature exceeds 250° C. However, this is not the case with aromatic acid anhydrides (e.g., phthalic anhydride, and methyltetrahydrophthalic anhydride) since these compounds are less likely to polymerize because of steric hindrance. Examples of such decomposing agents include benzoic anhydride, acetic anhydride, phthalic anhydride, and butyl glycidyl ether.

If the decomposing agent contains a hydroxyl group in addition to the functional group of the present invention, it can react with amino groups present in the decomposed substance of the resin to convert the amino groups to hydroxyl groups. For this reason, it is preferred to use a decomposing agent that contains a hydroxyl group along with the functional group of the present invention to facilitate the bond formation in the reproduction of urethane resin from the urethane decomposed substance. Examples of such decomposing agents include lactic acid, salicylic acid, and citric acid.

Decomposing Catalysts

When necessary, a decomposing catalyst may be added to the urethane resin and the decomposing agent to increase the rate of urethane degradation. Preferred catalysts are those commonly used in the production of urethane, including triethylamine, N,N-dimethylcyclohexylamine, N,N,N′,N′-tetramethylethylenediamine, N,N,N′,N′-tetramethylpropane-1,3-diamine, N,N,N′,N′-tetramethylhexane-1,6-diamine, N,N,N′,N″,N″-pentamethyldiethylenetriamine, N,N,N′,N″,N″-pentamethyldipropylenetriamine, tetramethylguanidine, triethylenediamine, N,N′-dimethylpiperazine, N-methyl-N′-(2-dimethylamino)ethylpiperazine, N-methylmorpholine, N-(N′,N′-dimethylaminoethyl)morpholine, 1,2-dimethylimidazole, hexamethylenetetramine, dimethylaminoethanol, dimethylaminoethoxyethanol, N,N,N′-trimethylaminoethylethanolamine, N-methyl-N′-(2-hydroxyethyl)piperazine, N-(2-hydroxyethyl)morpholine, bis(2-dimethylaminoethyl)ether, ethyleneglycol bis(3-dimethyl)aminopropylether, stannus octoate, dibutyltin diacetate, dibutyltin dilaurate, dibutyltin mercaptide, dibutyltin thiocarboxylate, dibutyltin dimaleate, dioctyltin mercaptide, dioctyltin thiocarboxylate, lead octenoate, and potassium octenoate. The decomposing catalyst is preferably added in an amount of 0.01 parts by weight to 10 parts by weight, and more preferably in an amount of 0.1 parts by weight to 5 parts by weight with respect to 100 parts by weight of the decomposing agent. When contained in an amount exceeding 10 parts by weight, the decomposing catalyst makes it difficult to control the reaction during the recycle process. On the other hand, the decomposing catalyst, when contained in an amount of less than 0.01 parts by weight, may not exhibit sufficient catalytic activity.

Amount of Decomposing Agent

While urethane resin and the decomposing agent of the present invention may be mixed with each other at any suitable ratio, the two components are preferably mixed such that the amount of the aforementioned functional groups present in the decomposing agent is from 0.1 to 3 equivalents with respect to 1 equivalent of the urethane/urea bond present in the urethane resin. When it is difficult to determine the amount of isocyanate contained in the urethane material as in the case of wasted urethane materials, the decomposing agent is added preferably in an amount of 1 to 300 parts by weight, more preferably in an amount of 5 to 100 parts by weight with respect to about 100 parts by weight of the urethane resin. If the amount of the decomposing agent is too large, then the decomposing agent may remain in the decomposed substance and may adversely affect the recycle process of the resin, whereas insufficient degradation may result if the amount of the decomposing agent is too small.

Degradation Temperature

While the degradation of urethane resin may be carried out at any suitable temperature, it is preferably carried out at a temperature in the range of 80 to 300° C., and more preferably in the range of 150 to 280° C., in order to improve efficiency. When the decomposing agent is provided in the form of solid, the degradation is preferably carried out at a temperature higher than or equal to the melting point of the decomposing agent. The resin may undergo unfavorable thermal decomposition at temperatures higher than 300° C., whereas it takes a substantial amount of time for the resin to decompose at temperatures lower than 80° C.

In the manner described above, the amount of amines in the decomposed substance of urethane resin can be reduced to some extent without a special amine-processing step. However, when it is desired to further reduce the amount of amines, the decomposing agent can again be added to the resulting decomposed substance. In this way, the decomposing agent reacts with aromatic diamines that were not captured in the degradation step and further reduces their amounts. Preferably, this reaction is carried out at a temperature of 200° C. or below, and more preferably at a temperature of 150° C. or below although the reaction may be carried out at any suitable temperature. If the reaction temperature is too high, decomposition of urethane may further proceed and further aromatic amines may be generated.

Degradation Apparatus

The degradation of urethane resin by the decomposing agent can be carried out by placing the urethane resin, the decomposing agent, and if necessary, the decomposing catalyst, in any container that can be heated, and heating and stirring the mixture. When the urethane resin to be decomposed is a foamed urethane resin or other porous urethane resin, the degradation apparatus is preferably of the type that can provide heating, pressurizing, and mixing at once so that the heating of the urethane resin, as well as the mixing of the urethane resin with the decomposing agent, can be done in a quick and uniform manner. Many of carboxylic acids and acid anhydrides are solids and when they are used in a batch process, the heat conduction tends to be slow. As a result, the decomposing agent often remains unmelted, keeping the reaction from proceeding any further. For this reason, an extruder is preferably used for carboxylic acids and acid hydrides.

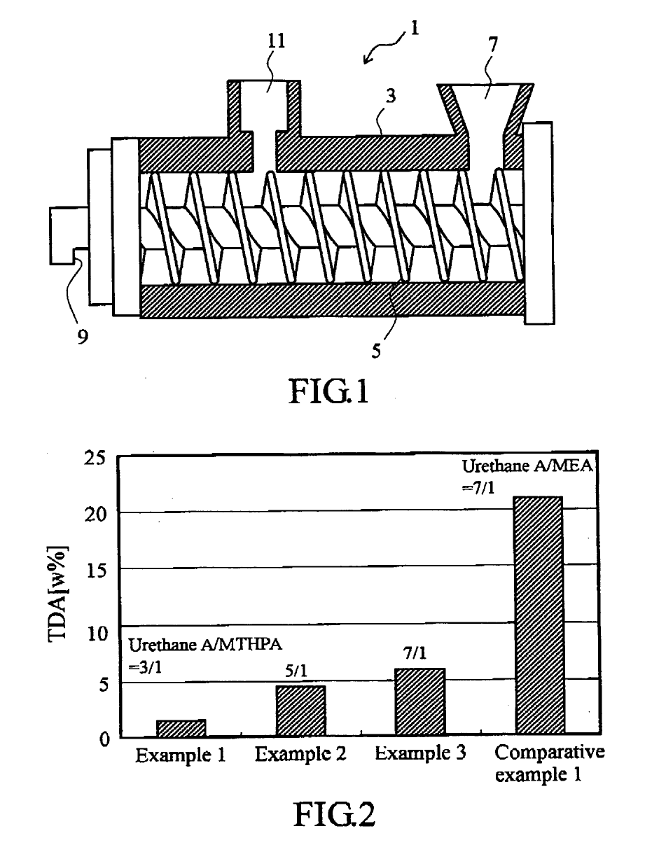

Shown in FIG. 1 is an exemplary extruder 1 suitable for this purpose. The extruder 1 can decompose a urethane resin in a continuous and efficient manner. The extruder 1 includes a cylinder unit 3 equipped with an adjustable heater, a rotatable screw 5 disposed within the cylinder unit 3 with its outer surface in contact with the inner surface of the cylinder unit 3, a feed port 7 formed on one end of the cylinder unit 3, a discharge port 9 formed on the other end of the cylinder unit 3, and a supply port 11 positioned between the feed port 7 and the discharge port 9. The heater of the cylinder unit 3 can be adjusted so that the cylinder unit 3 has different local temperatures. For instance, the temperature can be varied between an upstream region and a downstream region of the supply port 11.

Upon operation of the extruder 1, the temperature of the cylinder unit 3 is set at a predetermined temperature at which urethane resin starts to decompose, and the rotation speed of the screw 5 is set at a predetermined speed so that the rotation of the screw 5 causes the fed material to travel from the feed port 7 to the supply port 11 in the same length of time that it takes urethane resin to decompose. A urethane resin and a decomposing agent is then fed to the cylinder unit 3 from the feed port 7. The fed urethane resin moves toward the discharge port 9 while it is progressively decomposed. If necessary, a second supply of the decomposing agent is supplied to the decomposed product of the urethane resin from the supply port 11. The processed decomposed substance of the urethane resin is then discharged from the discharge port 9.

By employing a carboxyl compound or a derivative thereof to serve as the decomposing agent, the above-described embodiment allows efficient degradation of urethane resin. In addition, the resultant urethane resin decomposed substance contains little amines and can thus be used as a suitable material for recycling the resin.

[Second Embodiment]

In a second embodiment of the present invention, epoxy compounds or isocyanate compounds are used to serve as a decomposing agent of urethane resin.

In this embodiment, the same types of urethane resin as those used in the first embodiment are processed.

Decomposing Agents: Decomposing Agents Containing Epoxy Group

Examples of the decomposing agents for use in the present embodiment include ethylene oxide, propylene oxide, butylglycidyl ether, allylglycidyl ether, allyl-2,3-epoxypropyl ether, benzylglycidyl ether, butanedioldiglycidyl ether, butyl-2,3-epoxypropyl ether, ethyleneglycol diglycidyl ether, phenylglycidyl ether, 1,2-epoxyethylbenzene, 2,3-epoxy-1-propanol, 2,3-epoxypropylmethylether. Other examples include common epoxy resins such as bisphenol-A epoxy resins, bisphenol-F epoxy resins, phenol novolac epoxy resins, cresol novolac epoxy resin, naphthol-based novolac epoxy resins, bisphenol-A novolac epoxy resins, naphthalene diol epoxy resins, alicyclic epoxy resins, epoxy resins derived from tri- or tetra-(hydroxyphenyl)alkanes, bishydroxybiphenyl-based epoxy resins, and epoxides of phenol aralkyl resins.

Decomposing Agents: Decomposing Agents Containing Isocyanate Group

Examples of the isocyanate decomposing agents for use in the present embodiment include monoisocyanate compounds such as phenyl isocyanate, compounds having at lease two isocyanate group such as diphenyl methane diisocyanate (MDI), tolylene diisocyanate, xylylene diisocyanate, tetramethylxylylene diisocyanate, 3-isocyanatomethyl-3,5-5-trimethylcyclohexylisocyanate, 4,4′-methylenebis(cyclohexylisocyanate), bis(isocyanatomethyl)cyclohexane, and hexamethylenediisocyanate, and polymerized compounds such as polymeric MDI.

These decomposing agents may be used either individually or as a mixture of two or more decomposing agents. The decomposing agents may be mixed with a known decomposing agent, such as a polyol, amine, and alkanolamine.

Amount of Decomposing Agent

As opposed to the first embodiment, in which the decomposing agent can be added at substantially any proportion, the amount of the decomposing agent of the second embodiment, which contains epoxy groups or isocyanate groups, must be strictly restricted to a predetermined range so that 0.1 to 2 equivalents of the above-described functional groups are present with respect to 1 equivalent of urethane/urea bonds in the urethane resin material. When added in an amount greater than 2 equivalents, the decomposing agent may remain in the decomposed substance. This is unfavorable since the decomposing agent may undergo homopolymerization and may solidify if it is the epoxy-containing decomposing agent and the decomposing agent can become highly toxic if it contains isocyanate groups.

When added in an amount of less than 0.1 equivalent, either type of the decomposing agent cannot bring about sufficient degradation, nor can it decompose the urethane in a sufficiently short period of time. Either case is industrially unfavorable.

In this embodiment, the same decomposing catalysts and degradation apparatus as those described in the first embodiment may be used. Also, the degradation process can be carried out in the same temperature range as that specified in the first embodiment.

[Third Embodiment]

Method for Recycling the Decomposed Substance of Urethane Resin

The decomposed substances obtained by the processes described in the first and second embodiments above can be used as a fuel without any further processing, or they may be subjected to separation/purification processes to serve as materials for various chemical products. Also, the decomposed substances may be used as materials for resins. To make a new resin from the decomposed substance, a recycling agent, such as an epoxy resin or an isocyanate compound, may be added to the decomposed substance of the urethane resin to cause condensation reaction.

The epoxy resin and the isocyanate compound for use as the recycling agent for reproducing a new resin from the decomposed substance of urethane resin may be properly selected from known compounds commonly used for this purpose. After mixing with the recycling agent, the decomposed substance of urethane resin is shaped into a resin material using a proper shaping process.

Reproduction Using Epoxy Resin

The epoxy resin used for this purpose may be any resin that has two or more epoxy groups within one molecule. Examples include bisphenol-A epoxy resins, bisphenol-F epoxy resins, phenol novolac epoxy resins, cresol novolac epoxy resin, naphthol-based novolac epoxy resins, bisphenol-A novolac epoxy resins, naphthalene diol epoxy resins, alicyclic epoxy resins, epoxy resins derived from tri- or tetra-(hydroxyphenyl)alkanes, bishydroxybiphenyl-based epoxy resins, and epoxides of phenol aralkyl resins. These epoxy compounds may be used either individually or as a mixture of two or more compounds.

When a liquid epoxy resin is used as the recycling agent, the decomposed substance and the epoxy resin are mixed with each other in a universal stirrer and the mixture is poured into a mold in a temperature range of room temperature to 200° C. The mixture is then heat-cured for one hour to one night to obtain a molded product. Upon mixing, particles of organic or inorganic compounds may be added to serve as a filler. A plasticizer or a coupling agent may also be added. If necessary, a commercially available epoxy resin-curing agent may also be added to serve as an auxiliary curing agent.

Reproduction Using Isocyanate Compound

The isocyanate compound used for this purpose may be any isocyanate compound that has two or more isocyanate groups within one molecule. Examples include diisocyanate compounds, such as 1,5-naphthalene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, 2,2,4-trimethylhexamethylene diisocyanate, cyclohexane-1,4-diisocyanate, xylylene diisocyanate, isophorone diisocyanate, pyridine diisocyanate, dicyclohexylmethane-4,4-diisocyanate, and methylcyclohexane diisocyanate; polyfunctional isocyanate compounds, such as dimethylenetriphenylmethane tetraisocyanate, triphenylmethane triisocyanate, and polymethylenepolyphenyl polyisocyanate; and compounds obtained through addition reaction of a polyol such as glycerol and trimethylolpropane with any of the diisocyanate compounds above. These isocyanate compounds may be used either individually or as a mixture of two or more compounds.

When it is desired to form a urethane foam, a mixture of decomposed substance and the isocyanate compound is injected into a mold and is molded at a temperature in the range of room temperature to 200° C. since the addition of the isocyanate compound to the decomposed substance facilitates the bond formation and foaming, which proceed at a rate depending on the temperature. When necessary, a polyol compound, which serves as a material for urethane resin, a foaming agent, a foam stabilizer, a filler, or a catalyst may be added to the decomposed substance.

The decomposed substance of urethane resin may be used in the form of a solid product obtained by cooling the decomposed substance. In such a case, the solid product and the solid epoxy resin or the solid isocyanate compound are crushed and are mixed with woodflour or grains of an inorganic material. The mixture is then cured by heating/pressurizing on a press to obtain a shaped product. While the temperature for curing may vary depending on the melting points or the softening points of the urethane decomposed substance, the epoxy resin, and the isocyanate compound, it is preferably in the range of 80° C. to 200° C.

Containing a polyol, which serves as a material for urethane resin, and an amine, which forms the backbone of isocyanate, and derivatives and oligomers thereof, the decomposed substance has substantially the same properties as the material used to form the original urethane, the material to be decomposed. Thus, the resin regenerated by the above-described method has substantially the same characteristics as urethane resins or epoxy resins obtained by an ordinary process and can thus be used as a material for molded products or in coatings, adhesives and various other applications.

### EXAMPLES

The present invention will now be described with reference to examples. A urethane resin known as urethane resin A is used in each example. Urethane resin A is a flexible urethane widely used as a cushioning material. The material of urethane resin A contains approximately 25% by weight of TDI with respect to the entire urethane.

### Example 1

Urethane resin A and phthalic anhydride are mixed at a weight ratio of 3:1. The mixture was placed in a test tube and the tube was placed in an oil bath maintained at 190° C. to conduct a degradation test. The number of equivalents of the decomposing agent used was 2.61 with respect to 1 equivalent of urethane/urea bond in urethane resin A. During the test, the urethane was constantly mixed and pressurized with a glass rod. After heating and stirring for 7 minutes, the urethane was completely decomposed to form a viscous liquid.

### Examples 2 through 12

In each of Examples 2 through 12, the degradation test was conducted in the same manner as in Example 1, except that a different decomposing agent was used. For each example, the type of the decomposing agent used, the number of equivalents of the decomposing agent used with respect to 1 equivalent of isocyanate in the material, and the time that it took for the urethane resin to decompose completely are shown in Table 1 below.

TABLE 1

| | | Eq. of | Time required |
|---|---|---|---|
| | | decomposing | for urethane |
| Example | Decomposing agent | agent | degradation |
| Example 1 | phthalic anhydride | 2.62 | 7 min |
| Example 2 | phthalic acid | 2.36 | 10 min |
| Example 3 | methyltetrahydro | 2.34 | 7 min |
| | phthalic anhydride | | |
| Example 4 | hexahydrophthalic | 2.52 | 7 min |
| | anhydride | | |
| Example 5 | succinic anhydride | 3.89 | 4 min |
| Example 6 | benzoic anhydride | 1.76 | 7 min |
| Example 7 | acetic anhydride | 3.81 | 9.5 min |
| Example 8 | salicylic acid | 1.41 | 11 min |
| Example 9 | lactic acid | 2.63 | 14 min |
| Example 10 | citric acid | 2.02 | 12 min |
| Example 11 | MDI | 1.55 | 11 min |
| Example 12 | butyl glycidyl ether | 1.49 | 18 min |

### Example 13

1 part by weight of hexamethylenetetramine to serve as a catalyst was added to, and dissolved in, 100 parts by weight of hexahydrophthalic anhydride. The number of equivalents of the decomposing agent used was 2.52 with respect to 1 equivalent of isocyanate in the material. Urethane resin A and the decomposing agent was added at a weight ratio of 3:1 and a degradation test was conducted in the same manner as in Example 1. After 5 minutes, the urethane was completely dissolved to form a uniform decomposed substance.

### Examples 14 through 17

In each of Examples 14 through 16, the urethane resin A was decomposed in the same manner as in Example 13, except that a different catalyst was used. In Example 17, urethane resin A was decomposed using the same catalyst as that used in Example 13, but in a different amount. All the other conditions were the same as in Example 13. For each example, the type and the amount of the decomposing agent, and the time that it took for the urethane resin to decompose completely are shown in Table 2 below.

TABLE 2

| | | | Time required for |
|---|---|---|---|
| | | Amount of | urethane |
| Example | Catalyst | catalyst | degradation |
| Example 13 | hexamethylenetetramine | 1 part | 5 min |
| Example 14 | dibutyltin dilaurate | 1 part | 6 min |
| Example 15 | potassium octoate | 1 part | 5.5 min |
| Example 16 | lead octoate | 1 part | 6 min |
| Example 17 | hexamethylenetetramine | 5 parts | 4.25 min |

### Example 18

A degradation test was conducted by successively feeding urethane resin A and methyltetrahydrophthalic anhydride to an extruder schematically depicted in FIG. 1. The components were fed so that the weight ratio of urethane resin A to the methyltetrahydrophthalic anhydride was 3:1. The number of equivalents of the decomposing agent used was 2.34 with respect to 1 equivalent of isocyanate in the material. The cylinder unit was heated to 270° C. and the rotation of the screw was controlled so that it took 5 minutes for the material to pass the cylinder unit. The supply port 11 was not used. A paste-like decomposed substance composed of completely decomposed urethane resin was discharged from the discharge port. The decomposed substance was subjected to GC/MS analysis. The results of the analysis indicated that the decomposed substance contained approximately 1.4 wt % of TDA. Though two types of TDA, 2,4-tolylene diamine and 2,6-tolylene diamine, were detected, their amounts were added to give the total amount of TDA.

### Example 19

A degradation test was conducted in the same manner as in Example 18, except that the weight ratio of urethane resin A to the decomposing agent was 7:1. The number of equivalents of the decomposing agent used was 1.00 with respect to 1 equivalent of isocyanate in the material. Analysis of the resulting decomposed substance indicated that the product contained approximately 4.36 wt % of TDA.

### Example 20

A degradation test was conducted in the same manner as in Example 18, except that the weight ratio of urethane resin A to the decomposing agent was 15:1. The number of equivalents of the decomposing agent used was 0.46 with respect to 1 equivalent of isocyanate in the material. Analysis of the resulting decomposed substance indicated that the product contained approximately 6.14 wt % of TDA.

### Comparative Example 1

A degradation test was conducted in the same manner as in Example 18, except that monoethanolamine was used as the decomposing agent and the weight ratio of urethane resin A to the decomposing agent was 7:1. Analysis of the resulting decomposed substance indicated that the product contained approximately 21.14 wt % of TDA.

FIG. 2 shows the relationship between the weight ratio of the urethane resin to the decomposing agent and the TDA generation for each of Examples 18 through 20 and Comparative Example 1. It can be seen from FIG. 2 that any of the decomposing agents of the present invention significantly suppressed the generation of aromatic amines as compared to the conventional amine-based decomposing agent.

### Example 21

A degradation test was conducted by successively feeding urethane resin A and methyltetrahydrophthalic anhydride to an extruder schematically depicted in FIG. 1. The components were fed so that the weight ratio of urethane resin A to the methyltetrahydrophthalic anhydride was 7:1. The number of equivalents of the decomposing agent used was 1.00 with respect to 1 equivalent of isocyanate in the material. The cylinder unit was heated to 270° C. and the rotation of the screw was controlled so that it took 4 minutes for the material to pass the cylinder unit. The supply port 11 was not used. A paste-like decomposed substance composed of completely decomposed urethane resin was discharged from the discharge port. The decomposed substance was subjected to GC/MS analysis. The results of the analysis indicated that the decomposed substance contained approximately 4.9 wt % of TDA.

### Example 22

Urethane was decomposed in the same manner as in Example 21, except that the time required for the material to pass the cylinder unit (retention time, hereinafter) was set to 3 minutes. Analysis of the resulting decomposed substance indicated that the product contained approximately 4.2 wt % of TDA.

### Example 23

Urethane was decomposed in the same manner as in Example 21, except that the retention time was set to 2 minutes. Analysis of the resulting decomposed substance indicated that the product contained approximately 2.8 wt % of TDA.

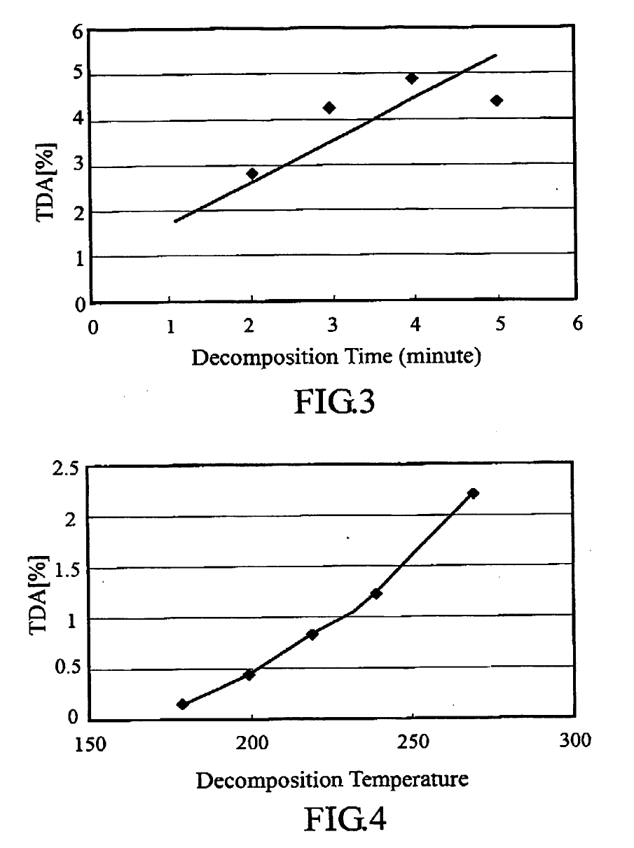

FIG. 3 shows the effect of the retention time for each of Examples 21 through 23 and Example 19. As can be seen, a short retention time tends to result in a decreased generation of TDA.

### Example 24

A degradation test was conducted by successively feeding urethane resin A and methyltetrahydrophthalic anhydride to an extruder schematically depicted in FIG. 1. The components were fed so that the weight ratio of urethane resin A to the methyltetrahydrophthalic anhydride was 4:1. The number of equivalents of the decomposing agent used was 1.78 with respect to 1 equivalent of isocyanate in the material. The cylinder unit was heated to 270° C. and the rotation of the screw was controlled so that it took 2 minutes for the material to pass the cylinder unit (i.e., retention time=2 min). The supply port 11 was not used. A paste-like decomposed substance composed of completely decomposed urethane resin was discharged from the discharge port. The decomposed substance was subjected to GC/MS analysis. The results of the analysis indicated that the decomposed substance contained approximately 2.2 wt % of TDA.

### Examples 25 through 28

Urethane was decomposed in the same manner as in Example 24, except that the temperature was maintained in the range of 180 to 240° C. The relationship between the amount of TDA in the decomposed substance and the temperature of the decomposing apparatus was shown in Table 3 and FIG. 4 for each of Examples 25 through 28. As can be seen from the graph, little TDA generation was observed when the temperature of the apparatus was 200° C. or below.

TABLE 3

| | Temperature (° C.) | TDA (%) |
|---|---|---|
| Example 24 | 270 | 2.2 |
| Example 25 | 240 | 1.2 |
| Example 26 | 220 | 0.8 |
| Example 27 | 200 | 0.4 |
| Example 28 | 180 | 0.1 |

### Examples 29 through 40 and Comparative Example 2

A degradation test was conducted in the same manner as in Example 26, except that a different decomposing agent was used in combination with urethane resin A. Data were also taken for the case in which monoethanolamine was used as the decomposing agent. The type of the decomposing agent, the number of equivalents of the decomposing agent with respect to 1 equivalent of isocyanate in the material, and the TDA content are shown in Table 4 below. The results indicate that the use of any of the decomposing agents of Examples 29 through 40 resulted in a significant decrease in the TDA content.

TABLE 4

| | | Eq. of | |
|---|---|---|---|
| | | degradating | |
| | Decomposing agent | agent | TDA (%) |
| Example 26 | methyltetrahydrophthalic | 1.76 | 0.8 |
| | anhydride | | |
| Example 29 | phthalic anhydride | 1.96 | 0.7 |
| Example 30 | phthalic acid | 1.78 | 0.9 |
| Example 31 | hexahydrophthalic anhydride | 1.90 | 0.8 |
| Example 32 | succinic anhydride | 2.92 | 0.4 |
| Example 33 | benzoic anhydride | 1.32 | 0.7 |
| Example 34 | acetic anhydride | 2.86 | 0.9 |
| Example 35 | adipic acid | 2.00 | 0.5 |
| Example 36 | salicylic acid | 1.06 | 0.4 |
| Example 37 | lactic acid | 1.97 | 0.4 |
| Example 38 | glycine | 1.94 | 1.2 |
| Example 39 | MDI | 1.16 | 0.6 |
| Example 40 | butyl glycidyl ether | 1.12 | 0.5 |
| Comp. Ex. 2 | monoethanolamine | — | 12.0 |

### Example 41

A decomposing agent was prepared by dissolving 1 part by weight of hexamethylenetetramine to serve as a catalyst in 100 parts by weight of methyltetrahydrophthalic anhydride. Using this decomposing agent, urethane was decomposed in the same manner as in Example 18 to obtain a paste-like liquid. The liquid product appeared to be somewhat less viscous than the product obtained in Example 18. Analysis of the resulting decomposed substance indicated that the product contained approximately 1.2 wt % of TDA.

### Example 42

Urethane resin A and methyltetrahydrophthalic anhydride were successively fed to an extruder schematically depicted in FIG. 1 from the feed port 7. The components were fed so that the weight ratio of urethane resin A to the methyltetrahydrophthalic anhydride was 6:1. The same amount of the decomposing agent as that fed from the feed port was then added through the supply port 11. It was observed that the urethane had already been decomposed by the time it passed below the supply port 11. The final ratio of urethane to the decomposing agent was 3:1. The cylinder unit was heated to 250° C. in the region upstream of the supply port (i.e., upstream region) and to 180° C. in the region downstream of the supply port and upstream of the discharge port (i.e., downstream region). The rotation of the screw was controlled so that it took 4 minutes for the material to pass the cylinder unit (i.e., retention time). A paste-like decomposed substance was discharged from the discharge port. The total number of equivalents of the decomposing agent used was 1.17 with respect to 1 equivalent of isocyanate in the material. Analysis of the decomposed substance revealed that the product contained only approximately 0.3 wt % TDA.

### Example 43

A degradation test was conducted in the same manner as in Example 42, except that the temperature of the downstream region of the cylinder unit was adjusted to 130° C. A paste-like decomposed substance was discharged from the discharge port. Analysis of the decomposed substance revealed that the product contained only 0.1 wt % TDA.

### Example 44

A degradation test was conducted in the same manner as in Example 42, except that the temperature of the downstream region of the cylinder unit was adjusted to 230° C. A paste-like decomposed substance was discharged from the discharge port. Analysis of the decomposed substance revealed that the product contained only 0.9 wt % TDA. A comparison among Examples 25, 26, and 27 implies that most of the generated TDA can be captured when the urethane material is maintained at 180° C. or below after the second addition of the decomposing agent.

### Example 45

To 100 parts by weight of the urethane decomposed substance obtained in Example 18, 40 parts by weight of a polyol POP-36/42 along with 5 parts by weight of water were added. Subsequently, 20 parts by weight of COSMONATE T-80, an isocyanate product, were added and the mixture was thoroughly mixed. The mixture was heated in an oven at 100° C. for 1 hour. This resulted in the formation of an elastic foam.

### Example 46

To 20 parts by weight of the urethane decomposed substance obtained in Example 18, 30 parts by weight of an epoxy resin (EP4100E, ASAHI DENKA Co., Ltd.) was added and the mixture was heated overnight in an oven at 150° C. This resulted in the formation of a brown recycled resin.

As set forth, the present invention allows a greater reduction of amino compounds generated during degradation of urethane resins than is possible by any of the conventional solutions. Thus, the present invention significantly facilitates recycling of urethane resins.

What is claimed is:

1. A method for processing a urethane resin, comprising the step of adding to a urethane resin a decomposing agent that contains at least one functional group selected from the group consisting of a carboxyl group (—COOH), and a salt of the carboxyl group, an ester of the carboxyl group and an acid anhydride of the carboxyl group (—CO—O—CO—).

2. The method according to claim 1, wherein the decomposing agent is added in an amount that provides 0.1 to 3 equivalents of the functional group for each equivalent of isocyanate group present in the urethane resin.

3. The method according to claim 1, wherein the decomposing agent is an anhydride of a polycarboxylic acid.

4. The method according to claim 3, wherein the decomposing agent is at least one selected from the group consisting of phthalic anhydride, methyltetrahydrophthalic anhydride, hexahydrophthalic anhydride, and succinic anhydride.

5. A method for processing a urethane resin, comprising the step of adding to a urethane resin a decomposing agent containing at least one functional group selected from the group consisting of an isocyanate group (—NCO) and an epoxy group, the decomposing agent being added in an amount that provides 0.1 to 2 equivalents of the functional group for each equivalent of isocyanate group present in the urethane resin.

6. The method according to claim 1, wherein the decomposing agent further contains at least one hydroxyl group.

7. The method according to claim 2, wherein the decomposing agent further contains at least one hydroxyl group.

8. The method according to claim 5, wherein the decomposing agent further contains at least one hydroxyl group.

9. The method according to claims 1, wherein the urethane resin and the decomposing agent are mixed under pressurized and heated condition.

10. The method according to claims 2, wherein the urethane resin and the decomposing agent are mixed under pressurized and heated condition.

11. The method according to claims 5, wherein the urethane resin and the decomposing agent are mixed under pressurized and heated condition.

12. A decomposed substance of a urethane resin characterized in that it is produced by decomposing a urethane resin by adding to the urethane resin any one of a decomposing agent that contains at least one functional group selected from the group consisting of a carboxyl group (—COOH), a salt of the carboxyl group, an ester of the carboxyl group and an acid anhydride group of the carboxyl group (—CO—O—CO—), and a decomposing agent that contains at least one functional group selected from the group consisting of an isocyanate group (—NCO) and an epoxy group.

13. The urethane decomposed substance according to claim 12, wherein the decomposing agent is an anhydride of a polycarboxylic acid.

14. The urethane decomposed substance according to claim 13, wherein the decomposing agent is at least one selected from the group consisting of phthalic anhydride, methyltetrahydrophthalic anhydride, hexahydrophthalic anhydride, and succinic anhydride.

15. A method for producing a recycled resin, comprising the steps of adding to a urethane resin any one of a decomposing agent that contains at least one functional group selected from the group consisting of a carboxyl group (—COOH), and a salt of the carboxyl group, an ester of the carboxyl group and an acid anhydride of the carboxyl group (—CO—O—CO—), and a decomposing agent that contains at least one functional group selected from the group consisting of an isocyanate group (—NCO) and an epoxy group to thereby decompose the urethane resin; and reacting the resultant decomposed substance of the urethane resin with a compound that contains at least one functional group selected from the group consisting of an epoxy group and an isocyanate group.

16. The method according to claim 15, wherein the decomposing agent is an anhydride of a polycarboxylic acid.

17. The method according to claim 16, wherein the decomposing agent is at least one selected from the group consisting of phthalic anhydride, methyltetrahydrophthalic anhydride, hexahydrophthalic anhydride, and succinic anhydride.

18. A recycled resin characterized in that it is produced by adding to a urethane resin any one of a decomposing agent that contains at least one functional group selected from the group consisting of a carboxyl group (—COOH) and a salt of the carboxyl group, an ester of the carboxyl group and an acid anhydride (—CO—O—CO—) of the carboxyl group, and a decomposing agent that contains at least one functional group selected from the group consisting of an isocyanate group (—NCO) and an epoxy group; and then reacting the resultant decomposed substance of the urethane resin with a compound that contains at least one functional group selected from the group consisting of an epoxy group and an isocyanate group.

19. The recycled resin according to claim 18, wherein the decomposing agent is an anhydride of a polycarboxylic acid.

20. The recycled resin according to claim 19, wherein the decomposing agent is at least one selected from the group consisting of phthalic anhydride, methyltetrahydrophthalic anhydride, hexahydrophthalic anhydride, and succinic anhydride.
